(19) United States
(12) Patent Application Publication
(10) Pub. No.: US 2006/0222815 A1
(43) Pub. Date: Oct. 5, 2006

(54) Use of particles hydrophobized by fluorosilanes for the production of self-cleaning surfaces having lipophobic, oleophobic, lactophobic and hydrophobic properties

(75) Inventors: Markus Oles, Hattingen (DE); Edwin Nun, Billerbeck (DE)

Correspondence Address: C. IRVIN MCCLELLAND;OBLON, SPIVAK, MCCLELLAND, MAIER & NEUSTADT, P.C., 1940 DUKE STREET, ALEXANDRIA, VA, 22314, US

(73) Assignee: DEGUSSA AG, DUESSELDORF (DE)

(21) Appl. No.: 10/556,092

(22) PCT Filed: Apr. 21, 2004
(86) PCT No.: PCT/EP04/50577

§ 371 Date: Nov. 9, 2005

(30) Foreign Application Priority Data
May 15, 2003 (DE) 103 21 851.3

(51) Int. Cl. B05D 1/12; B32B 5/16

(52) U.S. Cl. 428/145; 427/180; 428/323

(57) ABSTRACT

The invention relates to the use of microparticles hydrophobized with fluorosilanes or -siloxanes for producing surfaces which have self-cleaning and also lactophobic, oleophobic and lipophobic properties. The use of microparticles hydrophobized with fluorosilanes in the known processes for producing self-cleaning surfaces makes it possible to produce surfaces which have not only self-cleaning properties but also lipophobic, oleophobic and lactophobic properties. Articles finished with such surfaces are especially easy to clean easily with removal of oil-, grease- or milk-containing soilings. The inventive use is therefore especially suitable for producing industrial textiles, workwear and children's clothing.

The invention relates to the use of particles hydrophobized with fluorosilanes or -siloxanes for producing self-cleaning surfaces with lipophobic, oleophobic, lactophobic and hydrophobic properties, and also to articles with such surfaces.

Water-repellant, i.e. hydrophobic, surfaces have been known for some time. Fine silica particles in particular can be functionalized with perfluorooctylethyltrichlorosilanes and can subsequently be suspended in a UV-curable coating (JP 09-220518). The curing of this matrix leads to coatings which impart enhanced water-repellant properties to polymethyl methacrylate PMMA.

A further development of the water-repellant surfaces are self-cleaning surfaces which can be cleaned to remove impurities by moving water. The production of such surfaces has been described many times before. The fact that water droplets roll off hydrophobic surfaces, particularly when they are structured, but without recognizing self-cleaning, was described as early as 1982 by A. A. Abramson in Chimia i Shisn russ. 11, 38. For self-cleaning surfaces, not only a suitable structure but also a specific surface chemistry is required. A suitable combination of structure and hydrophobicity makes it possible for even small amounts of moving water on the surface to entrain adhering soil particles and clean the surface (WO 96/04123; U.S. Pat. No. 3,354,022, C. Neinhuis, W. Barthlott, Annals of Botany 79, (1997), 667). This combination of structure and chemistry can be achieved, for example, by means of an embossing process in a hydrophobic coating. Equally possible are also injection-molding processes and hot-embossing processes.

The state of the art regarding self-cleaning surfaces is, according to EP 0 933 388, that an aspect ratio of >1 and a surface energy of less than 20 mN/m are required for such self-cleaning surfaces. In this context, the aspect ratio is defined as the quotient of mean height to mean width of the structure. The aforementioned criteria are realized in nature, for example in the lotus leaf. The surface of a plant, formed from a hydrophobic, waxlike material, has elevations which are separated from one another by up to a few μm. Water droplets come into contact essentially only with the tips of the elevations. Such water-repellant surfaces have been described many times in the literature. An example thereof is an article in Langmuir 2000, 16, 5754, by Masashi Miwa et al., which states that contact angle and roll-off angle increase with increasing structuring of artificial surfaces formed from boehmite, applied to a spin-coated varnish layer and subsequently calcined.

In addition to this shaping of structures by suitable tools, particulate systems have also been developed. The production of structures for self-cleaning by application of particles to a surface was described for the first time in JP 07-328532 In this case, hydrophobic fine silica particles were fixed to a surface with a resin film. The Swiss patent CH-268258 describes a process in which structured surfaces are obtained by applying powders such as kaolin, talc, clay or silica gel. The powders are fixed to the surface by oils and resins based on organosilicon compounds. In more recent times, particulate systems have been developed which are based on nanoparticles with a very hydrophobic surface, as described, for example, in DE 10129116, DE 10138036 and DE 10134477. The nanoparticles are bonded to the substrate either

a) by a carrier layer or

b) by direct incorporation of the particles into the polymer/substrate.

The latter documents describe the use of different hydrophobic particles for obtaining hydrophobic, self-cleaning surfaces which have essentially water-repellant properties. The result is that, although many soil types do not remain adhering to such surfaces or can be washed off again by moving water, grease- or oil-containing, especially liquid soil, for example the famous “sauce stain” or “grease stain”, always presents a problem, since such soil can adhere to the surface equipped with hydrophobic particles owing to its low hydrophilicity.

It is therefore an object of the present invention to provide a means of finishing surfaces in such a way that they have not only water-repellant and self-cleaning properties, but are also insensitive toward oil- or grease-containing soils.

It has been found that, surprisingly, the use of particles which have been hydrophobized with fluorosilanes or -siloxanes for producing surfaces with self-cleaning properties makes it possible to obtain surfaces which have not only hydrophobic but also lactophobic, oleophobic and lipophobic properties.

The present invention therefore provides for the use of particles which have been hydrophobized with fluorosilanes or -siloxanes for producing surfaces which have self-cleaning properties and a surface structure with elevations which are formed by the microparticles, the surfaces produced having not only self-cleaning properties but also oleophobic, lipophobic and lactophobic properties.

The present invention likewise provides articles having at least one surface with self-cleaning, hydrophobic, lipophobic, oleophobic and lactophobic properties, produced by the use of microparticles hydrophobized with fluorosilanes or -siloxanes, the articles being, for example, a textile, an advertising medium, an awning material, a covering film, an industrial nonwoven, an item of clothing, outdoor clothing, rainwear, workwear, children's clothing, protective clothing, a semifinished product, a film or an article made of plastic.

The use of particles hydrophobized with fluorosilanes or -siloxanes for producing surfaces has the advantage that surfaces produced in this way have not only hydrophobic, but also lipophobic, oleophobic and lactophobic properties. These properties achieve the effect that even oil- or grease-containing soil particles and especially oil- or grease-containing liquid soils can be removed again in a simple manner from the surfaces. For example, milk or sauce stains roll off the surfaces in a simple manner without surfactants or grease dissolvers having to be used. These properties of surfaces are of particular interest for the surfaces of textiles. The use of particles treated with fluorosilanes or -siloxanes is therefore particularly advantageous for producing workwear, table textiles or babywear or children's clothing, since these textiles come into contact particularly frequently with grease- or oil-containing soils, frequently including liquid soils.

The invention is described below by way of example without being restricted to these embodiments.

The inventive use of microparticles hydrophobized with fluoroalkylsilanes or -siloxanes for producing surfaces which have self-cleaning properties and a surface structure with elevations which are formed by the microparticles is notable in that the surfaces produced have not only self-cleaning properties but also oleophobic, lipophobic and lactophobic properties.

The surface structure with self-cleaning properties formed by the microparticles preferably has elevations with a mean height of from 20 nm to 25 μm and a mean separation of from 20 nm to 25 μm, preferably having a mean height of from 50 nm to 10 μm and/or a mean separation of from 50 nm to 10 μm and most preferably having a mean height of from 50 nm to 4 μm and/or a mean separation of from 50 nm to 4 μm. Most preferably, the inventive sheet extrudates surfaces have elevations with a mean height of from 0.25 to 1 μm and a mean separation of from 0.25 to 1 μm. In the context of the present invention, the mean separation of the elevations means the distance of the highest elevation of one elevation to the next highest elevation: When an elevation has the shape of a cone, the tip of the cone is the highest elevation of the elevation. When the elevation is a cuboid, the uppermost surface of the cuboid is the highest elevation of the elevation.

The self-cleaning properties are attributable to the wetting properties which can be described by the contact angle that a water droplet forms with a surface. A contact angle of 0 degrees means full wetting of the surface. The static contact angle is measured generally by means of units in which the contact angle is measured visually. On smooth hydrophobic surfaces, static contact angles of less than 125° are typically measured. The present self-cleaning surfaces have static contact angles of preferably greater than 130°, preferentially greater than 140° and most preferably greater than 145°. It has also been found that a surface has good self-cleaning properties only when it has a difference between advancing and receding angle of not more than 10°, which is why inventive surfaces preferably have a difference between advancing and receding angle of less than 10°, preferably less than 5° and most preferably less than 4°. For the determination of the advancing angle, a water droplet is placed on the surface by means of a cannula and the droplet on the surface is enlarged by adding water through the cannula. During the enlargement, the edge of the droplet slides over the surface and the contact angle is advancing angle determined. The receding angle is measured on the same droplet, except that water is removed from the droplet through the cannula and the contact angle is measured during the reduction of the droplet. The difference between the two angles is referred to as hysteresis. The smaller the difference, the smaller the interaction of the water droplet with the surface of the substrate and the better the lotus effect (the self-cleaning property).

The inventive surfaces which have a surface structure with self-cleaning properties preferably have an aspect ratio of the elevations of greater than 0.15. The elevations which are formed by the particles themselves preferably have an aspect ratio of from 0.3 to 1, more preferably from 0.5 to 0.8, preference being given to aspect ratios of less than 1 only when the particles penetrate at least partly into the surface. The aspect ratio is defined as the quotient of maximum height to maximum width of the structure of the elevations.

The inventive surface can be formed by microparticles bonded firmly to the surface, i.e., for example, microparticles anchored at least partly within the surface, or by microparticles which lie on the surface and are bonded to it only by comparatively weak physical forces, i.e. microparticles not bonded permanently to the surface.

The microparticles which form the elevations and have been hydrophobized with fluorosilanes or -siloxanes may, for example, be selected from microparticles of silicates, minerals, metal oxides, metal powders, silicas, pigments or polymers. The microparticles are more preferably selected from pyrogenic silicas, precipitated silicas or alumina. Most preferably, the microparticles have pyrogenic silicas, especially those as obtainable, for example, under the trade name Aerosil® VPR 411 from Degussa AG.

Preferred microparticles have a particle diameter of from 0.02 to 100 μm, more preferably from 0.1 to 50 μm and most preferably from 0.1 to 30 μm. Suitable microparticles may also have a diameter of less than 500 nm or be combined from primary particles to form agglomerates or aggregates with a size of from 0.2 to 100 μm.

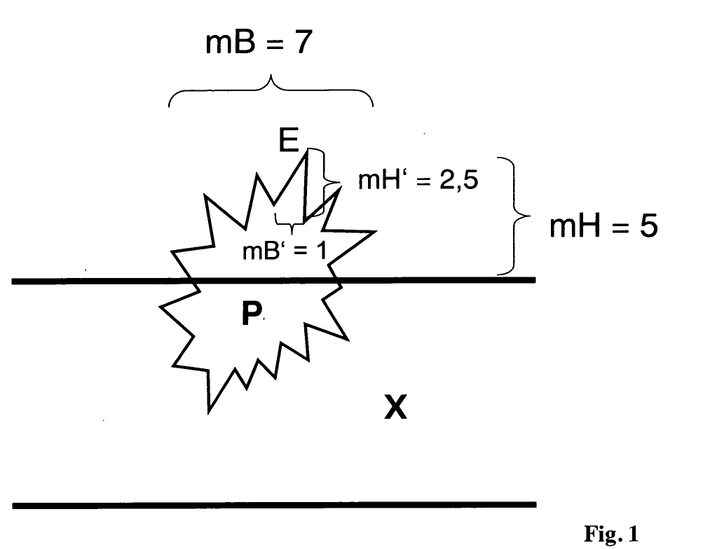

Particularly preferred microparticles which form the elevations of the structured surface are those which have an irregular fine structure in the nanometer range on the surface. The microparticles with the irregular fine structure preferably have elevations or fine structures with an aspect ratio of greater than 1, more preferably greater than 1.5. The aspect ratio is in turn defined as the quotient of maximum height to maximum width of the elevation. FIG. 1 schematically illustrates the difference of the elevations which are formed by the particles and the elevations which are formed by the fine structure. The figure FIG. 1 shows the surface of a sheet extrudate X which has particles P (for simplification of the illustration, only one particle is depicted). The elevation which is formed by the particle itself has an aspect ratio of approx. 0.71, calculated as the quotient of the maximum height of the particle mH, which is 5 since only some of the particle makes a contribution to the elevation, which protrudes from the surface X, and the maximum width mB which is 7 in relation thereto. A selected elevation of the elevations E which are present on the particles by virtue of the fine structure of the particles has an aspect ratio of 2.5, calculated as the quotient of the maximum height of the elevation mH′ which is 2.5 and the maximum width mB′ which is 1 in relation thereto.

It may be advantageous when the microparticles or the entire surface after the application of the microparticles to the surface is hydrophobized again with fluorosilanes or -siloxanes.

To hydrophobisize the particles before or after they are applied to the surface, they may be treated with a compound suitable for hydrophobization, selected, for example, from the group of the fluoroalkylsilanes or fluoroalkylsiloxanes, especially of the fluoroalkylalkoxysilanes or -siloxanes. The hydrophobization is effected preferably by crosslinking the hydrophobizing agent on the particle surface or by bonding the hydrophobizing agent to the particle surface. For this purpose, the silanes or siloxanes preferably have one or more alkoxy groups, for example ethoxy or methoxy groups, which react with the silanol groups present on the surface of the particles and form a strong chemical bond with elimination of the corresponding alcohol. Particularly preferred hydrophobizing agents are tridecafluorooctyltriethoxysilane and oligomers thereof, for example
DYNASYLAN® F 8261 tridecafluoro-1,1,2,2-tetrahydrooctyl-1-triethoxysilane,
DYNASYLAN® F 8850 3,3,4,4,5,5,6,6,7,7,8,8,8-tridecafluorooctyltriethoxyoligo-siloxane, prepared by HCl-catalyzed condensation of 3,3,4,4,5,5,6,6,7,7,8,8,8-tridecafluorooctyltriethoxysilane with 0.8 mol/mol of H₂O (dimer, trimer, tetramer), 50% by weight in ethanol,
DYNASYLAN® F 8262 alcoholic solution of activated fluoroalkyl functional organosilane analogously to example C/5a in DE 199 04 132 or EP 1 033 395 (Jenkner et al., Degussa-Hüls AG). For DYNASYLAN TM F 8262, ethanol is used in place of i-propanol. Composition: 1.0% by weight of 3,3,4,4,5,5,6,6,7,7,8,8,8-tridecafluorooctyltriethoxysilane, 0.126% by weight of H₂O, 0.074% by weight of HCl (absolute), 0.1% by weight of SnCl₂.2H₂O, 98.7% by weight of ethanol,
DYNASYLAN® F 8810 10% by weight aqueous solution of an oligomerized cocondensate of 3,3,4,4,5,5,6,6,7,7,8,8,8-tridecafluorooctyltriethoxysilane and 3-amino-propyltriethoxysilane analogously to example H2 in DE 198 23 390 (Standke et al., Degussa-Hüls AG).

The microparticles hydrophobized with fluorosilanes or -siloxanes can be used in all known processes for producing surfaces which have self-cleaning properties and a surface structure with elevations which are formed by the microparticles, under the prerequisite that no conditions (temperature, solvent, etc.) are employed in these processes under which the microparticles themselves or the hydrophobizing layer are damaged or destroyed.

Preference is given to the use of the microparticles hydrophobized with fluorosilanes or -siloxanes in processes in which the microparticles are applied to a surface and fixed to it dry, for example by spray application or powder application, preferably by spray application by means of an electrostatic spray gun. Processes in which the fixing is effected by means of carrier systems known. For instance, DE 101 18 345 and DE 101 18 352 state that the microparticles are sprayed or scattered onto a surface which has optionally been provided with a carrier layer and are subsequently fixed to the surface with by means of the carrier system or physically, for example by impressing into the surface. The impression can be effected, for example, during a conventional process step in a shaping process, for example injection molding, calendering, blow-molding, etc., in which case the microparticles are preferably impressed into the surface of a substrate which has not yet solidified. In DE 101 18 351, a self-cleaning surface is produced by mixing microparticles (Aerosil VPR 411) with fixative particles and subsequent application and fixing of this mixture to a surface. The application is effected preferably with an (electrostatic) spray gun.

It is likewise possible in accordance with the invention to use microparticles hydrophobized with fluorosilanes or -siloxanes in processes in which the microparticles are applied to a surface and fixed there as a dispersion, for example by spraying a dispersion of microparticles in a solvent which attacks neither the microparticle nor the fluorosilane or -siloxane, or immersion of an article into such a dispersion. The fixing can be effected in different ways. The examples mentioned here are just a few processes whose details can be taken from the corresponding documents. For instance, in DE 101 18 346 and DE 101 18 348, suspensions of microparticles in a solvent are applied to fibers or textiles and fixed by evaporating the solvent. The solvent is selected such that it starts to dissolve the fiber material. DE 101 18 349 describes a corresponding process in general terms for surfaces. In addition to solvents which start to dissolve or attack the surface, it is also possible to use those which only start to swell the surface. After the removal of the solvent, the swelling is reversed, which fixes microparticles partly to the surface. For temporary coatings, it is also possible to apply dispersions of solvents and microparticles to surfaces in which the solvent shows no interaction whatsoever with the material of the surface. In such processes, the microparticles are fixed after the evaporation of the solvent by means of weak interactions, for example van der Waals forces. Further processes in which the microparticles hydrophobized with fluorosilanes or -siloxanes can be used are possible and are apparent to the skilled person in an obvious manner.

In order to achieve the aspect ratios of the elevations mentioned in the processes in which the microparticles are impressed into a surface, it is advantageous when at least some of the particles, preferably more than 50% of the particles, are embedded into the surface only up to an extent of 90% of their diameter. The surface therefore preferably has particles which are anchored in the surface by from 10 to 90%, preferably from 20 to 50% and most preferably from 30 to 40%, of their mean particle diameter, and thus still protrude from the surface with parts of their inherently fissured surface. In this way, it is ensured that the elevations which are formed by the particles themselves have a sufficiently large aspect ratio of preferably at least 0.15. In this way, it is also achieved that the firmly bonded particles are bonded very durably to the surface. The aspect ratio is defined in this context as the ratio of maximum height to maximum width of the elevations. A particle which is assumed to have an ideal spherical shape and protrudes from a surface to an extent of 70% has an aspect ratio of 0.7 according to this definition.

The surfaces which can be produced by the process may, for example, be the surfaces of textiles, advertising media, awning materials, covering films, industrial nonwovens, items of clothing, outdoor clothing, rainwear, workwear, children's clothing, protective clothing, semifinished products, films or articles made of plastic.

The use of microparticles hydrophobized with fluorosilanes or -siloxanes in appropriate processes makes it possible to produce articles having at least one surface with self-cleaning, hydrophobic, lipophobic, oleophobic and lactophobic properties. These articles may, for example, be a textile, an advertising medium, an awning material, a covering film, an industrial nonwoven, an item of clothing, outdoor clothing, rainwear, workwear, children's clothing, protective clothing, a semifinished product, a film or an article made of plastic.

The process according to the invention is described with reference to the example which follows without the invention being restricted to this working example.

### EXAMPLE 1

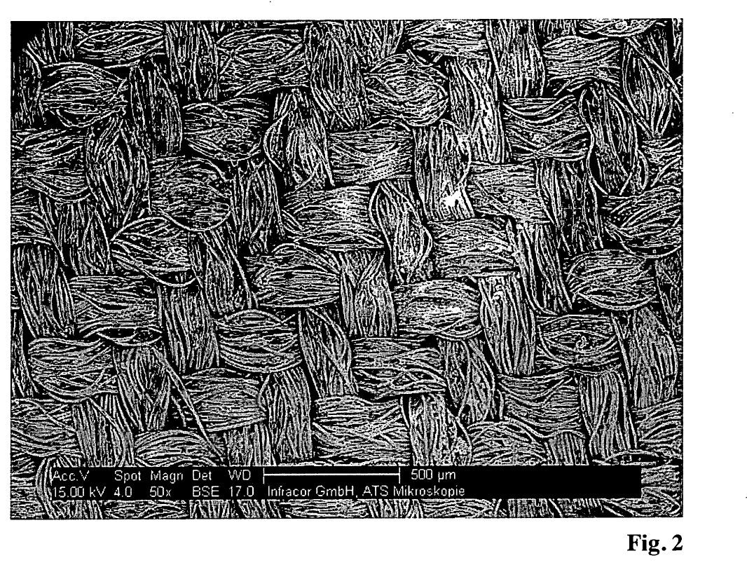

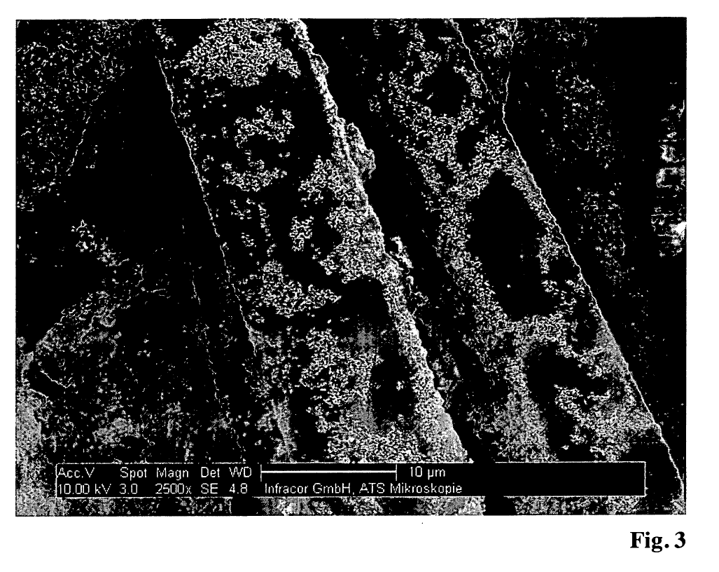

A commercial polyester fabric (PET, white, purchased from Karstadt, Bochum) with a fiber diameter of 10 μm is immersed into a dispersion comprising one part of ethanol, 10% by weight of Aerosil VPR 411 (based on the ethanol) and 9 parts by weight of toluene. After 5 seconds, the textile is pulled back out of the bath and dried at room temperature and subsequently heat-treated at 80° for 1 h. Subsequently, the properties of the textile were characterized. A water droplet (60 μl) rolls off the surface of its own accord at an angle of 21° to the horizontal. A soiling with toner dust (Printex 50, Degussa AG Dusseldorf) was removed fully with water. Silicone oil rolled off of its own accord at an angle of inclination to the horizontal of approx. 40° in comparison to a non-finished fabric. Commercial standard UHT milk (homogenized and pasteurized UHT milk, Milsani, ALDI) with a fat content of 1.5% likewise rolled off at an angle of inclination of approx. 40°. Water passed through the textile thus finished as the water column which had been built up exceeded a height of 3 cm (measured to DIN EN13562). A non-finished comparative specimen was wetted immediately and it was not possible to build up any water column. The figures FIG. 2 and FIG. 3 show scanning electron micrographs with different magnification of the textiles manufactured in example 1.

1. A method for producing surfaces which have self-cleaning properties and a surface structure with elevations which are formed by the microparticles, the surfaces produced having not only self-cleaning properties but also oleophobic, lipophobic and lactophobic properties,
the method comprising:
hydrophobizing microparticles with fluorosilanes or fluorosiloxanes to form a surface structure, the surface structure having elevations with a mean height of from 20 nm to 25 μm and a mean separation of from 20 nm to 25 μm, the microparticles having a particle diameter of from 0.02 to 100 μm and having been hydrophobized with fluoroalkylalkoxysilanes.

2. The method as claimed in claim 1,
wherein the microparticles are pyrogenic silica or precipitated silica particles hydrophobized with fluoroalkylalkoxysilanes.

3. The method as claimed in claim 1,
wherein the surfaces are the surfaces of textiles, advertising media, awning materials, covering films, industrial nonwovens, items of clothing, outdoor clothing, rainwear, workwear, children's clothing, protective clothing, semifinished products, films or articles made of plastic.

4. An article with at least one surface with self-cleaning, -hydrophobic, lipophobic, oleophobic and lactophobic properties,
wherein the article is coated with the hydrophobized microparticles of claim 1.

5. The article as claimed in claim 4,
wherein the article is a textile, an advertising medium, an awning material, a covering film, an industrial nonwoven, an item of clothing, an outdoor clothing, a rainwear, a workwear, a children's clothing, a protective clothing, a semifinished product, a film or an article made of plastic.
